(19) United States
(12) Patent Application Publication
(10) Pub. No.: US 2009/0010807 A1
(43) Pub. Date: Jan. 8, 2009

(54) DRUG CREATING SCREENING APPARATUS

(75) Inventors: Yasunori YOKOYAMA, Musashino-shi (JP); Takayuki KEI, Musashino-shi (JP); Kenta MIKURIYA, Musashino-shi (JP)

Correspondence Address: SUGHRUE-265550, 2100 PENNSYLVANIA AVE. NW, WASHINGTON, DC, 20037-3213, US

(73) Assignee: YOKOGAWA ELECTRIC CORPORATION, Musashino-shi (JP)

(21) Appl. No.: 12/113,998

(22) Filed: May 2, 2008

(30) Foreign Application Priority Data
May 23, 2007 (JP) 2007-136162

(51) Int. Cl. G01N 21/64

(52) U.S. Cl. 422/82.08

(57) ABSTRACT

A drug creating screening apparatus characterized in a drug creating screening apparatus including a well plate provided with a plurality of wells and glass brought into contact with a bottom face of the well plate for carrying out drug creating screening based on information of fluorescence emitted by irradiating exciting light to samples mounted between a plurality of the wells and the glass, wherein at least one opening portion for measuring a thickness of the glass is provided at the well plate.

### BACKGROUND OF THE INVENTION

The present invention relates to a drug creating screening apparatus for carrying out drug creating screening by carrying out an image processing based on a fluorescence signal emitted from a sample mounted to a well of a well plate, particularly, relates to a drug creating screening apparatus for automatically and highly accurately correcting a focusing error between lots of a well plate.

According to a drug creating screening apparatus, light of a specific wavelength is irradiated to samples aligned at wells (holes) in an array shape present at a well plate to excite, a fluorescence image generated from the excited sample is magnified by a microscope system, and a magnified image is taken by a camera. Further, the taken image is subjected to an image processing, and a sample constituting a candidate of a drug is found based on a result thereof. Further, a cofocal scanner is installed to promote an image quality of the image.

As prior art references of a drug creating screening apparatus using such a cofocal scanner, patent references shown below are known.
[Patent Reference 1] JP-A-2005-098722
[Patent Reference 2] JP-A-2005-095012
[Patent Reference 3] JP-A-2005-102629

Next, a drug creating screening apparatus of a background art will be explained in reference to FIG. 4. In a high content screen (HCS) procedure, previously cultured cells are dividedly injected to wells present at a well plate 30 by a pertinent number along with a culture solution, reagents of different concentrations, different amounts, or different kinds are dropped for respective wells to prepare a test sample. Next, the samples are excited by using light, and fluorescent images emitted from the excited samples are taken by a camera 40 by way of a microscope system 20. In order to acquire the fluorescent images from all of the wells, the well plate 30 is moved by an XY stage, not illustrated.

The images acquired by the camera 40 are subjected to an image processing, a sample constituting a candidate of a drug is found based on a result thereof. In order to promote an image quality of the image, a cofocal scanner 10 is installed between the microscope system 20 and the camera 40. An object lens of the microscope system 20 is designed to eliminate aberrations in consideration of a thickness of 0.17 mm of cover glass of the sample, and therefore, in order to acquire an image having a high quality, it is preferable to use glass of 0.17 mm also at a bottom face of the well plate.

However, generally, the bottom face of the well plate is not constituted by a complete plane but is provided with a distortion, further, a dispersion is present also in a thickness of a material (glass) of the bottom face. By the nonuniformity of the bottom face thickness, distances between the samples present at the individual wells and an object lens 21 of the microscope system 20 are not the same, and the images can be acquired or cannot be acquired depending on the wells as they are.

Hence, in order to firmly acquire the image, in a drug creating apparatus, the object lens 21 of the microscope 20 is provided with an auto-focused function and a focal point position of the object lens 21 is adjusted in accordance with the distortion of the bottom face of the well plate.

Next, a structure of the well plate 30 will be explained in reference to FIGS. 5A and 5B. According to FIG. 5A, the well plate 30 is provided with the wells 31 uniformly by a well plate framework 32. Further, FIG. 5B is a sectional view taken along a line A-A of FIG. 5A and a culture solution 33 is inputted to the wells 31. Further, ordinarily, there is carried out a way of use of inputting a reagent of the same kind at the same row of wells uniformly provided and changing concentrations thereof by respective columns. Bottom face glass 34 is brought into contact with the bottom face of the well plate 30.

Successively, a method of auto-focus will be explained in reference to FIG. 6. Focusing is carried out based on reflection of light from a lower face of the well plate bottom face glass 34, that is, a surface of glass. However, when reflectances of the surface and a back face of glass are compared, whereas since the surface is made to constitute a boundary having a large difference between refractive indices of air-glass, the reflectance is large, the back face is made to constitutes a boundary having a small difference between refractive indices of glass-culture solution, and therefore, the reflectance is small. When the both are compared, there is achieved an advantage that a focal point detecting accuracy is higher in the surface having the large reflectance.

A specific method will be described as follows. At a first well, a focused point Z₀ of the glass surface is searched, thereafter, a position Z_{f} at which the observed sample is seen the most clearly is searched by optical observation. An offset distance between the both is designated by notation Zₒₛ. At a second well and thereafter, after searching Z₀, the object lens is driven from the position by Zₒₛ to constitute focusing.

However, since a dispersion is present between lots in the thickness of the bottom face glass 34 of the well plate, in a case of adopting the above-described focusing method, when a plurality of sheets of the well plates are going to be observed, it is necessary to identify Zₒₛ sheet by sheet by optical observation.

Further, in order to automatically carry out the observation, there is a method of measuring the thickness of the glass from a difference between positions of detecting reflecting light at the two boundary faces of the back face and the surface of the glass. However, as described above, reflection of the back face is smaller than reflection of the surface. Therefore, a reflection signal of the surface effects an influence on a reflection signal of the back face as shown by notation A of FIG. 6. Therefore, an accuracy of detecting the back face is poor according to the method.

### SUMMARY OF THE INVENTION

The invention has been carried out in view of the problems and it is an object thereof to provide a drug creating screening apparatus for automatically and highly accurately correcting a focusing error between lots of a well plate.

In order to resolve such a problem, according to a first aspect of the invention, there is provided a drug creating screening apparatus, including:

a well plate provided with a plurality of wells, and

a glass brought into contact with a bottom face of the well plate, for carrying out drug creating screening based on information of fluorescence emitted by irradiating exciting light to samples injected to the plurality of wells,

wherein at least one portion for measuring a thickness of the glass is provided to the well plate.

According to a second aspect of the invention, there is provided a drug creating screening apparatus, including:

a well plate provided with a plurality of wells, and

a glass brought into contact with a bottom face of the well plate, for carrying out drug creating screening based on information of fluorescence emitted by irradiating exciting light to samples injected to the plurality of wells,

wherein at least one opening portion is provided to the well plate, and

wherein a thickness of the glass is measured based on reflection light from a surface and a back face of the glass brought into contact with the opening portion.

According to a third aspect of the invention, there is provided a drug creating screening apparatus, including:

a well plate provided with a plurality of wells, and

a glass brought into contact with a bottom face of the well plate, for carrying out drug creating screening based on information of fluorescence emitted by irradiating exciting light to samples injected to the plurality of wells,

wherein at least one opening portion is provided to the well plate,

wherein a thickness of the glass is measured based on reflection light from a surface and a back face of the glass brought into contact with the opening portion, and

wherein a focal point of an entire face of the well plate is controlled from the measured thickness of the glass and a reference point of a reflection signal of the glass surface brought into contact with the plurality of wells.

According to a forth aspect of the invention, there is provided the screening apparatus according to any one of the first to third aspects, wherein

the opening portion is a through hole provided at a nonwell portion of the well plate.

According to a fifth aspect of the invention, there is provided a drug creating screening apparatus, including:

a well plate provided with a plurality of wells, and

a glass brought into contact with a bottom face of the well plate, for carrying out drug creating screening based on information of fluorescence emitted by irradiating exciting light to samples injected to the plurality of wells,

wherein the well of the well plate is used for measuring a thickness of the glass.

According to a sixth aspect of the invention, there is provided a drug creating screening apparatus, including:

a well plate provided with a plurality of wells, and

a glass brought into contact with a bottom face of the well plate, for carrying out drug creating screening based on information of fluorescence emitted by irradiating exciting light to samples injected to the plurality of wells,

wherein a thickness of the glass is measured based on reflection light from a surface and a back face of the glass brought into contact with the well.

According to a seventh aspect of the invention, there is provided a drug creating screening apparatus, including:

a well plate provided with a plurality of wells, and

a glass brought into contact with a bottom face of the well plate, for carrying out drug creating screening based on information of fluorescence emitted by irradiating exciting light to samples injected to the plurality of wells,

wherein a thickness of the glass is measured based on reflection light from a surface and a back face of the glass brought into contact with the well, and

wherein a focal point of an entire face of the well plate is controlled from the measured thickness of the glass and a reference point of a reflection signal of a surface of the glass brought into contact with the plurality of wells.

In this way, the well plate is provided with at least one of the opening portion for measuring the thickness of the glass, and therefore, a focusing error between lots of the well plate can automatically and highly accurately be corrected.

### BRIEF DESCRIPTION OF THE DRAWINGS

FIG. 1 is an example of constituting a well plate of a drug creating screening apparatus according to the invention.

FIG. 2 is an explanatory view of an operation when focused by a drug creating screening apparatus according to the invention.

FIG. 3 is a constitution view of an application example of the invention.

FIG. 4 shows a constitution example of a drug creating screening apparatus of a background art.

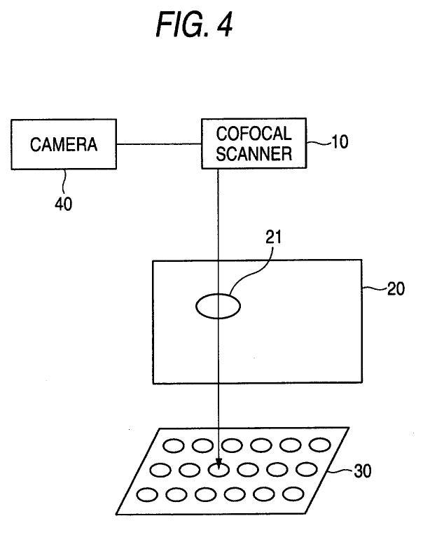

FIGS. 5A and 5B is a constitution example of a well plate of a drug creating screening apparatus of a background art.

FIG. 6 is an explanatory view of an operation when focused by the drug creating screening apparatus according to the invention.

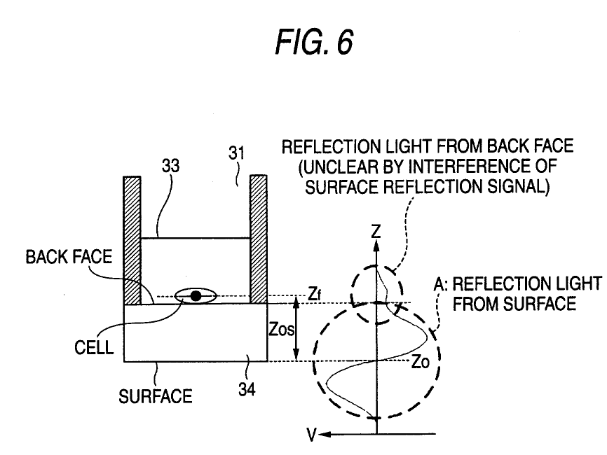

### DETAILED DESCRIPTION OF THE PREFERRED EMBODIMENTS

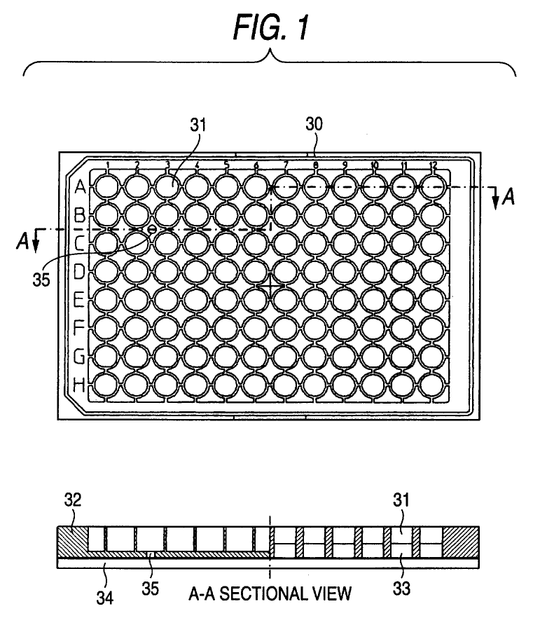

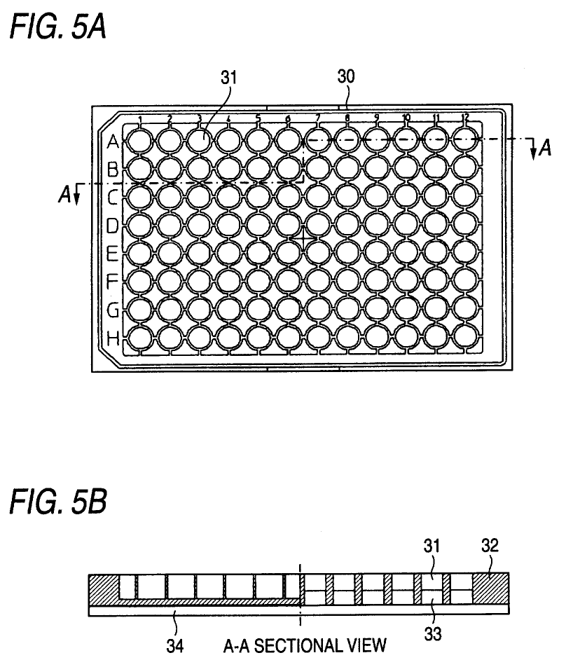

An explanation will be given of an example of constituting a drug creating screening apparatus of the invention in reference to FIG. 1. The drug creating screening apparatus is provided with an opening portion 35 for measuring a thickness of glass at a framework portion of a well plate as shown by FIG. 1. Other constitution is similar to that of FIGS. 5A and 5B, and therefore, an explanation thereof will be omitted.

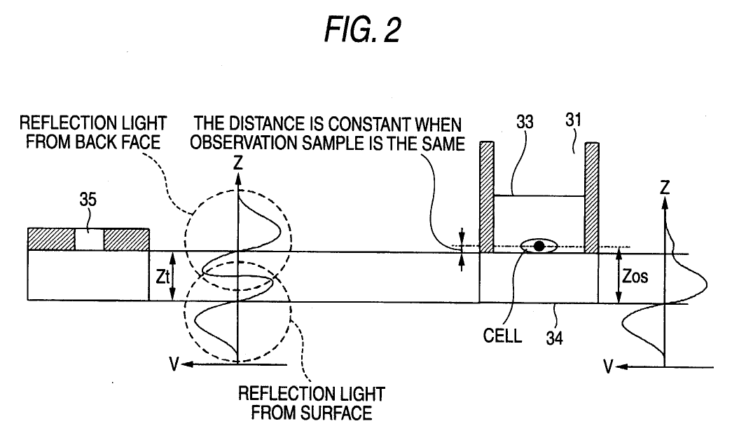

Next, an operation of the invention will be explained in reference to FIG. 2. FIG. 2 is an explanatory view of an operation of FIG. 1. When a plurality of sheets of well plates are automatically measured by using a well plate 30 of the invention, an automatic focusing is carried out by the following procedure.
a. At a first well hole (well 31) of a first sheet of a well plate, a position at which the observed sample is seen the most accurately by optical observation is focused. An offset amount between the position and a reference point of a reflecting signal of the surface is designated by Zₒₛ₁. Further, a suffix ‘1’ of Zₒₛ₁ signifies a first sheet of well plate.
b. In well holes of a second piece and thereafter of the first sheet of the well plate, the reference point of the reflection signal of the surface is searched, and focusing is constituted by moving an object lens from the point by Zₒₛ.
c. In an opening for measuring a glass thickness of the first sheet of the well plate, a thickness Zₜ₁ of the well is measured. Further, a suffix ‘1’ of Zₜ₁ signifies glass brought into contact with the first sheet of the well plate.
d. In a second sheet of well plate and thereafter, first, at an opening for measuring the glass thickness, a thickness Zₜ of glass is measured, from a difference between Zₜ₁ and Zₜ, an offset amount Zₒₛ=Zₒₛ₁+(Zₜ−Zₜ₁) is determined, and focusing is carried out at the respective well holes similar to the first sheet of the well plate. With regard to a significance of thickness Zₜ of glass without suffix, the thickness Zₜ signifies a thickness of glass which is going to be measured, that is, a thickness of glass other than the first sheet constituting the reference.

Further, although in explaining the operation, an explanation has been given of a method of measuring by using the well hole, the operations may be carried out by using the opening portion 35. At any rate, the back face of the bottom face glass 34 brought into contact with the opening portion 35 or the well hole and the surface of the bottom face glass 34 is brought into contact with air, and therefore, the reflection light firmly appears by the difference between the refractive indices of glass and air as in ‘reflection light from surface’ and ‘reflection light from back face’ of FIG. 2, reflection light not only from the surface of the glass 34 but also the rear face can be used usefully as measurement light.

In this way, by previously forming the opening portion at the well plate, or measuring the thickness of the bottom face glass sheet by sheet of the well plate by using the well hole, the focusing error between lots of the well plate can automatically and highly accurately determined.

Further, there is conceivable a method of promoting a glass thickness measurement accuracy by preparing a well hole in which the cells and the culture solutions are not inputted and constituting faces of glass-air for the surface and the back face. In the above-described explanation of the operation, the example of using the well hole is explained, and the focusing error between lots of the well plate can automatically and highly accurately be determined without a problem even by the method.

However, when the well hole for observation is used for such a use, since the way of use of inputting the same kind of the reagent to the same row and changing the concentration at the respective columns ordinarily is carried out, the well holes of the same row and the same column of the hole cannot effectively be used. In this respect, when the above-described operation is carried out by forming the opening portion 35, such a problem is not posed.

Next, an example of applying the invention will be explained. Although the invention intends to correct only an error between lots of the glass thickness of the bottom face of the well plate, strictly, a dispersion of the thickness of about several μm is present in glass of the same well.

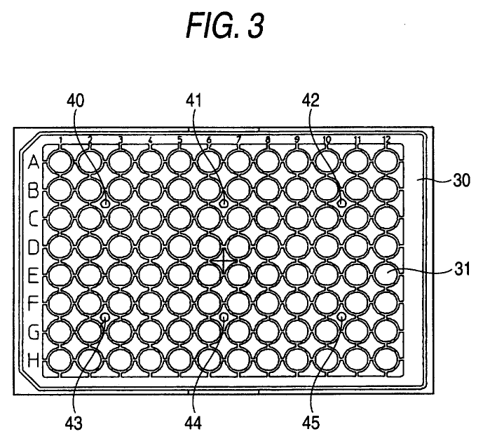

Hence, as shown by FIG. 3, a plurality of opening portions 40 through 45 for measuring a glass thickness as described above are opened, and the glass thickness is measured at a plurality of portions in one sheet of the well plate. In observing the sample, by using the glass thickness at a measurement point in correspondence with the well for correction, accuracy of automatic focusing can be promoted.

When a sample is going to be observed by an object lens having a high magnification, or a cofocal observation system, a dispersion in the glass thickness of about several um can effect a significant influence on the observed image, and therefore, the above-described method is effective.

What is claimed is:

1. A drug creating screening apparatus, comprising:
a well plate provided with a plurality of wells, and
a glass brought into contact with a bottom face of the well plate, for carrying out drug creating screening based on information of fluorescence emitted by irradiating exciting light to samples injected to the plurality of wells,
wherein at least one portion for measuring a thickness of the glass is provided to the well plate.

2. A drug creating screening apparatus, comprising:
a well plate provided with a plurality of wells, and a glass brought into contact with a bottom face of the well plate, for carrying out drug creating screening based on information of fluorescence emitted by irradiating exciting light to samples injected to the plurality of wells,
wherein at least one opening portion is provided to the well plate, and
wherein a thickness of the glass is measured based on reflection light from a surface and a back face of the glass brought into contact with the opening portion.

3. A drug creating screening apparatus, comprising:
a well plate provided with a plurality of wells, and
a glass brought into contact with a bottom face of the well plate, for carrying out drug creating screening based on information of fluorescence emitted by irradiating exciting light to samples injected to the plurality of wells,
wherein at least one opening portion is provided to the well plate,
wherein a thickness of the glass is measured based on reflection light from a surface and a back face of the glass brought into contact with the opening portion, and
wherein a focal point of an entire face of the well plate is controlled from the measured thickness of the glass and a reference point of a reflection signal of the glass surface brought into contact with the plurality of wells.

4. The screening apparatus according to claim 1, wherein
the opening portion is a through hole provided at a nonwell portion of the well plate.

5. A drug creating screening apparatus, comprising:
a well plate provided with a plurality of wells, and a glass brought into contact with a bottom face of the well plate, for carrying out drug creating screening based on information of fluorescence emitted by irradiating exciting light to samples injected to the plurality of wells,
wherein the well of the well plate is used for measuring a thickness of the glass.

6. A drug creating screening apparatus, comprising:
a well plate provided with a plurality of wells, and
a glass brought into contact with a bottom face of the well plate, for carrying out drug creating screening based on information of fluorescence emitted by irradiating exciting light to samples injected to the plurality of wells,
wherein a thickness of the glass is measured based on reflection light from a surface and a back face of the glass brought into contact with the well.

7. A drug creating screening apparatus, comprising:
a well plate provided with a plurality of wells, and
a glass brought into contact with a bottom face of the well plate, for carrying out drug creating screening based on information of fluorescence emitted by irradiating exciting light to samples injected to the plurality of wells,
wherein a thickness of the glass is measured based on reflection light from a surface and a back face of the glass brought into contact with the well, and
wherein a focal point of an entire face of the well plate is controlled from the measured thickness of the glass and a reference point of a reflection signal of a surface of the glass brought into contact with the plurality of wells.

8. The screening apparatus according to claim 2, wherein
the opening portion is a through hole provided at a nonwell portion of the well plate.

9. The screening apparatus according to claim 3, wherein
the opening portion is a through hole provided at a nonwell portion of the well plate.
